(19) United States
(12) Patent Application Publication
(10) Pub. No.: US 2008/0228115 A1
(43) Pub. Date: Sep. 18, 2008

(54) Massage chair

(76) Inventor: Eric Racoosin, Laguna Niguel, CA (US)

Correspondence Address: LAW OFFICES OF ERIC KARICH, 2807 ST. MARK DR., MANSFIELD, TX, 76063, US

(21) Appl. No.: 11/716,795

(22) Filed: Mar. 12, 2007

(51) Int. Cl. A61H 1/00

(52) U.S. Cl. 601/49

(57) ABSTRACT

A massage apparatus is disclosed comprising a frame, a rigid footplate, a resilient back support, a rigid backing member providing stiffening at least a portion of the back support, first and second vibration transducers providing a vibration force to the footplate and the back support, and the footplate and the back support are isolated from the frame. The back support forms an angle with the ground that is in a range from about 35 degrees to about 65 degrees, and the back support forms an angle with the footplate that is in a range from about 80 to about 100 degrees.

### BACKGROUND

This disclosure pertains generally to a massage apparatus, and more particularly to a massage apparatus that utilizes vibratory stimulus to relax and rejuvenate an end user.

Vibration stimulus has been widely accepted for use in the promotion of physical fitness, enhancing appearance, and improving circulation and the general health in humans of all ages. Furthermore, massage apparatuses have long incorporated vibratory stimulus, with end users finding the effects soothing and relaxing.

Examples of massage apparatuses incorporating vibratory stimulus include beds and lounge chairs or recliners with vibration transducers located in or behind padded cushions. Some variations of such beds, chairs, and recliners provide vibration transducers affixed to their frame structure.

Other examples include variations of a rigid plate having one or more vibration transducers acting thereon, also referred to as vibration plates. Some vibration plates are intended to be stood upon, thereby supporting the entire weight of the user. Vibration plates, by virtue of their rigidity, transmit vibration forces to the human body efficiently, and therefore may provide substantial benefits to the user. However, when an individual stands on a vibration plate, the vibratory stimulus is only transmitted effectively to the lower extremities of the body. Further, the user may experience an unpleasant sensation accompanied by blurred vision due to the entire body being subjected to the vibration stimulus. Recognizing this, other vibration plates exist that are intended to support only a part of the user's body, for example a leg, an arm, the back, etc., pinpointing that body part for treatment. Such examples are not effective for treating the entire body in a time efficient manner.

Other apparatuses incorporate a support member next to and at a different elevation to a vibration plate, whereby a portion of the end user's weight is supported by the surface, and the remaining portion is supported by the vibrating plate. For example, a known apparatus has a seating surface raised in relation to the vibrating plate, whereby feet may be placed on the vibrating plate while the person is seated. Since the user's upper body mass and a portion of the leg mass is supported by the seating surface, only the leg mass unsupported by the seat is subjected to vibration stimulus.

Some of the above vibration apparatuses are typically intended for clinical use, and/or may not provide balanced treatment to both the upper and lower body of the end user. In conjunction with the other previously mentioned deficiencies, it should be apparent that a need exists for an apparatus that affords the benefits of vibration stimulus to both the upper and lower extremities of the body, without discomfort, in a time effective manner.

### SUMMARY

A massage apparatus is disclosed which may provide the benefits of full body, or nearly full body, vibration stimulus in a time efficient manner that effectively reduces or eliminates discomfort. The apparatus may incorporate a rigid vibrating footplate, which may support a portion of the user's weight and transmit a first vibration stimulus via the feet. Further, the apparatus may incorporate a rigid vibrating backrest, incorporating a resilient support member, which may support a second portion of the user's weight thereby transmitting a second vibration stimulus generally via the end users back and surrounding area.

The apparatus may further include support members for the end user's arms and head, and may generally provide ease of ingress and egress. The configuration and geometry of the apparatus results in a distribution of the end user's mass over the various supporting surfaces that improves the distribution and effect of vibration stimulus. Vibration treatment time may therefore be reduced, lending the apparatus to applications unsuitable to previous vibration therapy apparatuses.

These and other features, aspects, and advantages of the massage apparatus in its various embodiments will become apparent after consideration of the ensuing description, the accompanying drawings, and the appended claims.

### BRIEF DESCRIPTION OF THE DRAWINGS

Embodiments of the present invention will now be described, by way of example only, with reference to the following drawings in which:

FIG. 1 is a perspective view of an embodiment of a massage apparatus in accordance with the present invention.

FIG. 2 is a perspective view of a portion of the massage apparatus of FIG. 1.

FIG. 3 is a perspective view of another portion of the massage apparatus of FIG. 1.

FIG. 4 (a) is a perspective view of a component of the massage apparatus of FIG. 1.

FIG. 4 (b) is a perspective view of a variation of the component of FIG. 4 (a).

FIG. 5 is a side view of the massage apparatus of FIG. 1.

FIG. 6 is a perspective view of another embodiment of the massage apparatus of FIG. 1.

FIG. 7 is a sectional view of the embodiment of FIG. 6, taken along the line VII-VII.

FIG. 8 (a) is a magnification of detail VIII(a) of the sectional view in FIG. 7.

FIG. 8 (b) is a magnification of detail VIII(b) of the sectional view in FIG. 7.

For the purposes of illustration these figures are not necessarily drawn to scale. In all of the figures, like components are designated by like reference numerals.

### DETAILED DESCRIPTION

Throughout the following description, specific details are set forth in order to provide a more thorough understanding of the embodiments. However, the invention may be practiced without these particulars. In other instances, well known elements have not been shown or described to avoid unnecessarily obscuring the invention. Accordingly, the detailed description and drawings are to be regarded in an illustrative rather than a restrictive sense.

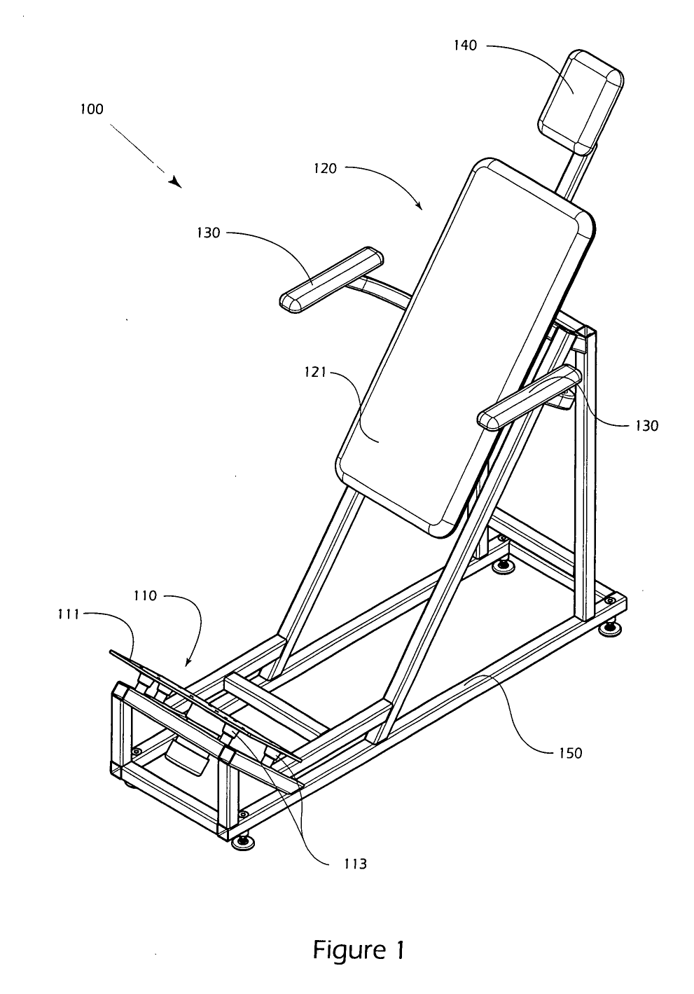

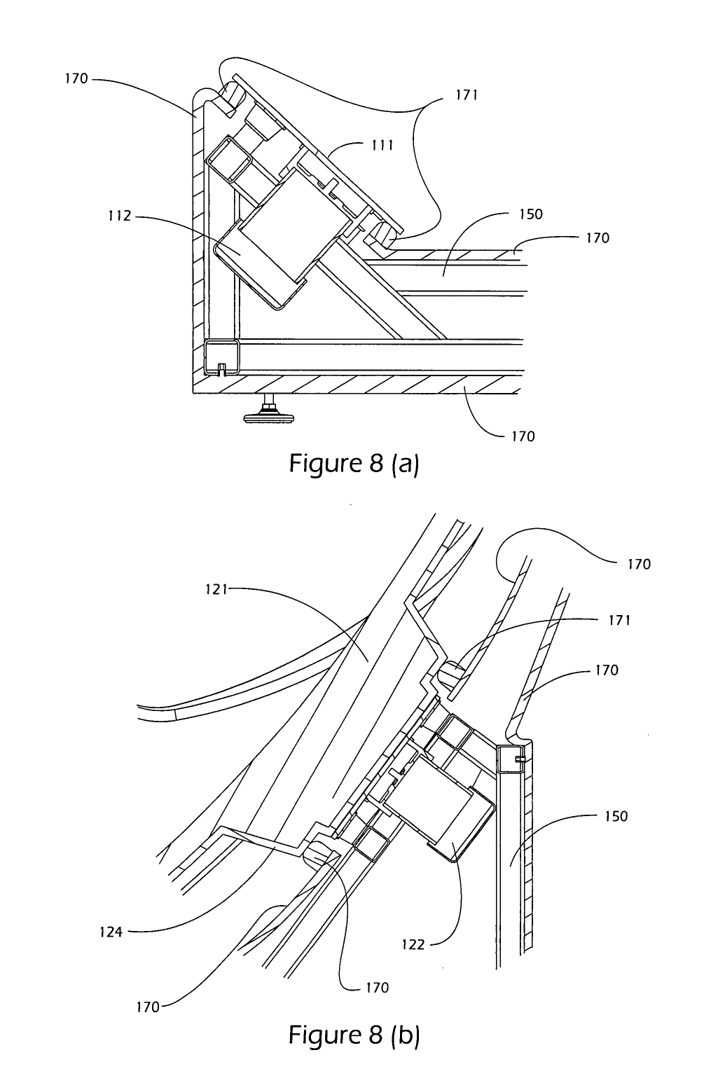

FIGS. 1-8 generally depict exemplary embodiments of a massage apparatus 100 and its components. With reference to FIG. 1, the apparatus may comprise a footplate assembly 110, a backrest assembly 120, armrests 130, a headrest 140, and a frame 150. Footplate assembly 110 may comprise a rigid plate 111 on which the end user (not shown) may rest the soles of his or her feet. Backrest assembly 120 may comprise a support member 121 which may generally support the back area of the end user's body. Generally, the back area may comprise at least a portion of the user's upper and lower back, but may further comprise the buttocks. For additional support of the user's body, the back area may further comprise a portion of the hind side of the user's upper leg, below the buttocks. Armrests 130 and headrest 140 may be optional features.

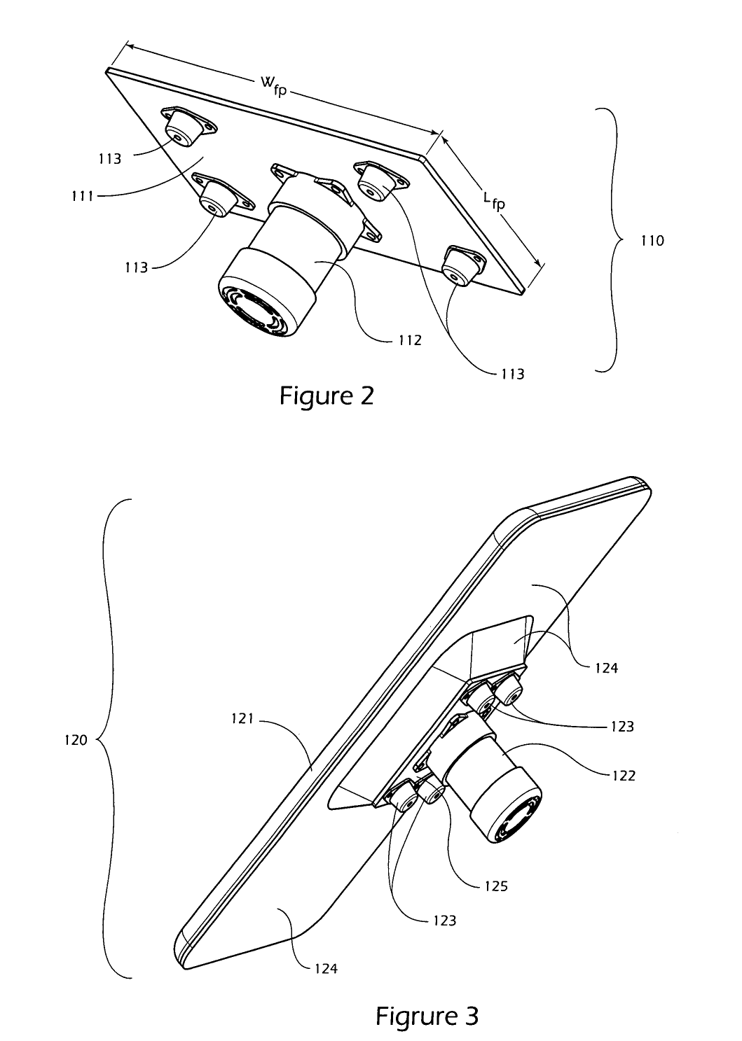

Footplate assembly 110 is generally shown in FIG. 2. In addition to rigid plate 111, the assembly 110 may comprise at least one vibration transducer 112. Transducer 112 may be attached to plate 111, and plate 111 may be sufficiently rigid to support an end user without undue deformation under his or her body weight and the vibration forces applied by transducer 112. Examples of materials which may be used for plate 111 include plastics, fiber reinforced plastics, laminates, wood, metals, and the like. Plate 111 may have a length L_{fp} large enough to accommodate an average adult's foot comfortably, however, it may not necessarily support the entire foot from heel to toe. Plate 111 may have a width W_{fp} which affords the end user a comfortable resting position, for example the shoulder width of an average adult. The thickness of plate 111 may be determined from load requirements and the material properties of the material selected for the plate. Plate 111 may further be provided with a tactile or high friction surface coating to limit slipping between the user's foot and the plate, for example a rubberized coating, grip tape, knurling, etc.

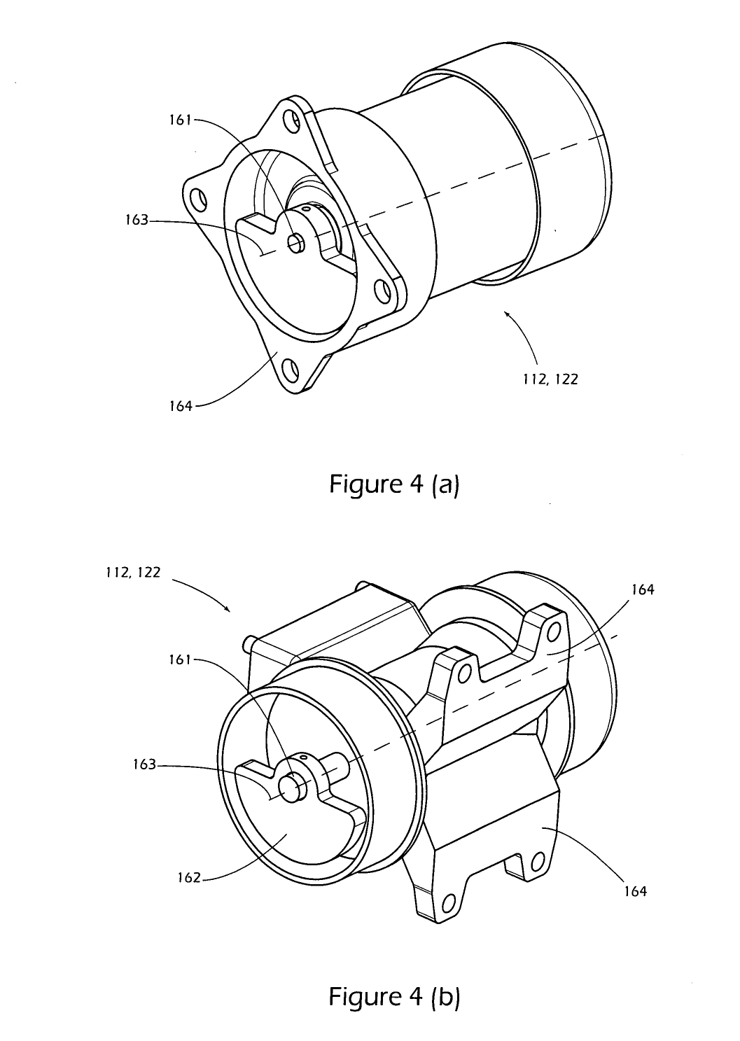

Backrest assembly 120 is generally shown in FIG. 3. Support member 121 may be resilient for added comfort to the user. Generally, support member 121 may be more resilient than plate 111. An exception may be where plate 111 may be provided with a surface coating. Support member 121 may be generally provided with at least one rigid backing member 124, which may provide stiffness to at least a portion of resilient surface 121. In one example, backing member 124 is made from plastic. Other examples of materials which may be used for the backing member include plastics, fiber reinforced plastics, laminates, wood, metals, and the like. Backrest assembly 120 further comprises a vibration transducer 122, which may be mounted to backing member 124 directly (not shown), or by means of a coupling member 125 as shown in FIG. 3.

Footplate assembly 110 and backrest assembly 120 may be isolated from frame 150, for example by means of isolation mounts 113 (see FIG. 2) and 123 (see FIG. 3), or any other suitable isolation means. Isolation mounts 113 may be attached directly to plate 111, isolating the footplate assembly from frame 150 as shown in FIGS. 1 and 2. Isolation mounts 123 may be mounted directly to backing member 124, or may be mounted to coupling member 125 as in FIG. 3. Coupling member 125, if provided, may be made from any material such as plastics, fiber reinforced plastics, laminates, wood, metals, and the like and mechanically fastened to the backing member.

Isolation mounts 113 and 123 may be attached to frame 150 and footplate and backrest assemblies 110 and 120 via any suitable means, for example mechanical fasteners, e.g. screws, rivets, adhesives, or the like.

Referring again to FIG. 3, support member 121 may be molded over or onto backing member 124. In another example, support member 121 may be adhered or otherwise fastened to backing member 124. Support member 121 may be provided with a protective cover forming its exterior surface, or the exterior surface may be formed integrally with the support member. Examples of materials which may be used to form support member 121 include rubberized foam, which may be provided with a smooth or textured closed cell exterior surface, or vinyl covered upholstery foam, among others. Regardless of the materials used to construct support member 121, the member should be resilient enough to provide comfort to the user while being sufficiently durable.

Many types of vibration transducers are known and may be adapted for use on apparatus 100. As examples, with reference to FIGS. 4 (a) and (b), transducer 112 and/or 122 may comprise a motor 160 having at least one rotating shaft 161 having an axis of rotation 163, and to which at least one eccentric mass 162 is attached. The rotating mass' center of gravity is located away from axis 163 resulting in a centripetal force normal to the axis of rotation 163. FIG. 4 (a) demonstrates an eccentric mass vibration transducer 112 or 122 which exerts a vibrational force substantially parallel to a mounting surface 164. FIG. 4 (b) demonstrates an eccentric mass vibration transducer 112 or 122 having the same elements as above, but which exerts a vibrational force substantially perpendicular to mounting surface 164. Other variations (not shown) include eccentric mass transducers generating vibrational forces both parallel and perpendicular to the mounting surface in one unit, or at a specified angle to the mounting surface.

It should be appreciated that various other vibration transducer configurations exist, e.g. eccentric shaft motors, reciprocating mass vibrators, alternating current field vibrators, and others readily known in the art, all of which may be used for either or both of transducers 112 and 122, in any combination.

Therapeutic effects may be achieved when transducers 112 and 122 produce a peak vibration force between about 50 pounds and about 150 pounds, at a frequency between about 30 Hz and about 90 Hz. In one example, transducers 112 and 122 may produce a peak vibration force between about 85 pounds and about 115 pounds, at a frequency between about 45 Hz and about 75 Hz. In yet another example, transducers 112 and 122 may produce a peak vibration force between about 95 pounds and about 105 pounds, at a frequency between about 50 Hz and about 70 Hz.

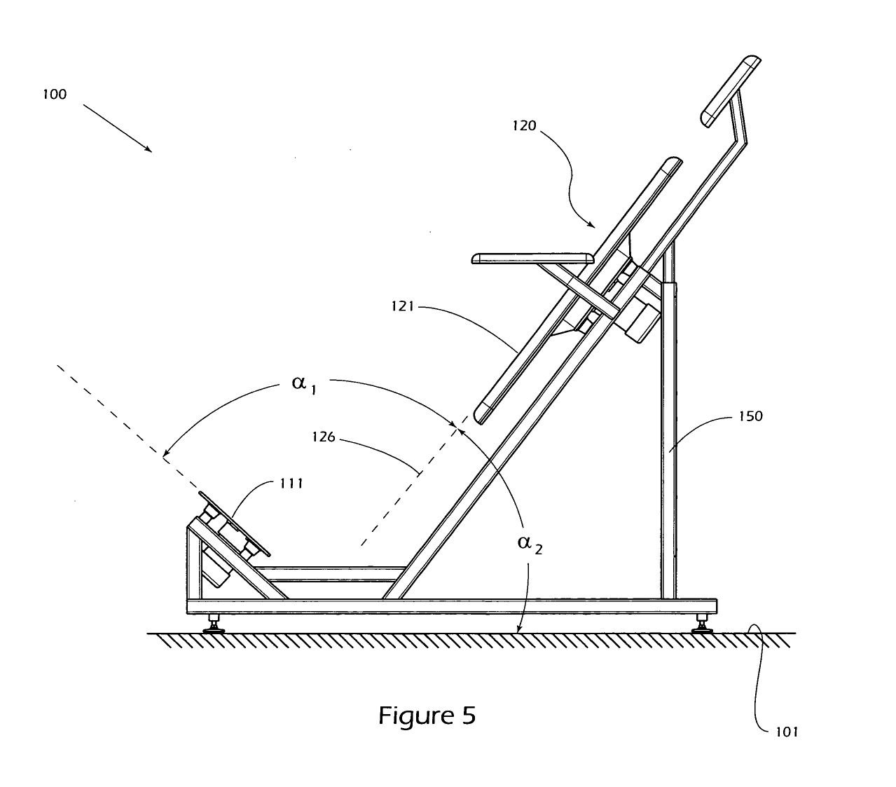

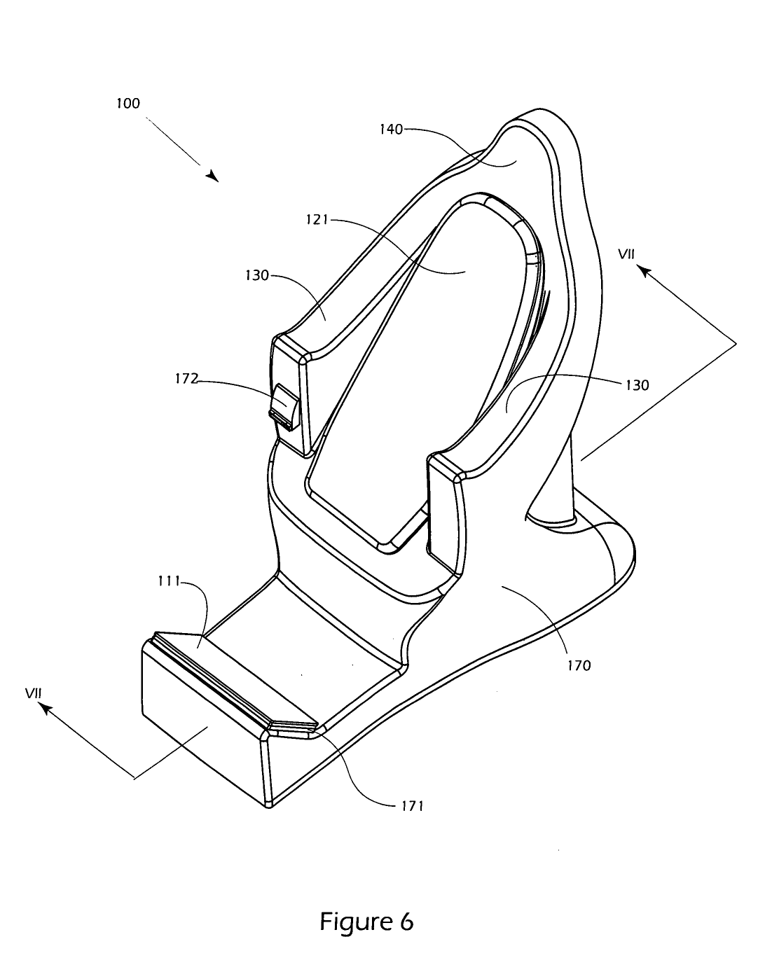

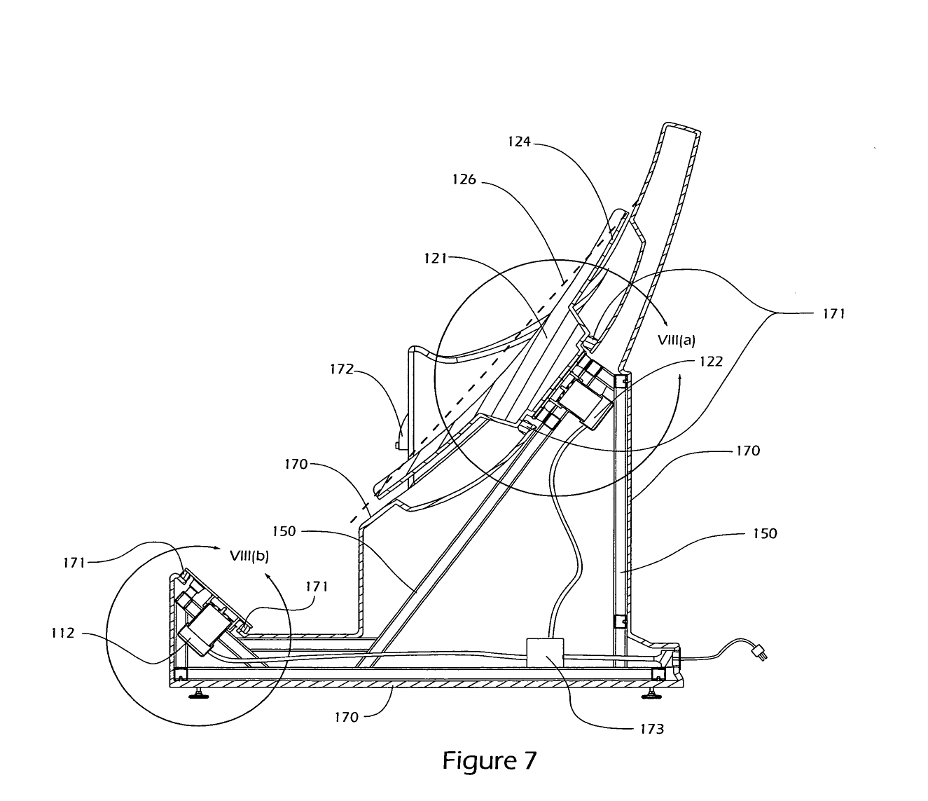

FIG. 5 illustrates the inclination of support member 121 relative to footplate 111 and ground 101. Support member 121 and footplate 111 may be generally separated by an included angle, α₁, ranging from about 75 degrees to about 100 degrees. It may be appreciated that support member 121 may not be planar in profile, but may have a generally contoured or curved profile (see FIG. 7) which may provide additional comfort for the end user. Referring to FIGS. 5 and 7, a straight line 126 or a plane (not shown) may extend along the general inclination of support member 121 as a reference for measuring angle α₁. For a curved support member 121 as in FIG. 7, it may be appreciated that line 126 approximates the angle of member 121's inclination, and may only be accurate to within about +/−5 degrees.

In one embodiment α₁, may have a value ranging from about 85 degrees to about 95 degrees.

Support member 121 may be inclined an angle α₂ relative to ground 101, as seen in FIG. 5. Angle α₂ may range from about 35 degrees to about 65 degrees. In one embodiment, angle α₂ may be in a range from about 45 degrees to about 60 degrees. In another embodiment, angle α₂ may have a value between about 50 degrees to about 55 degrees.

With α₁ and α₂ within the above ranges, advantages may include ease of ingress and egress in addition to an improved position for the end user of the massage apparatus. The position is generally inclined and supine, with the resulting body mass percentages distributed between the plate 111 and the support member 121, in conjunction with the parameters disclosed for the vibration inputs, providing a soothing and relaxing massage experience. Benefits may include alleviation of leg and foot cramps while simultaneously relaxing the upper body, ultimately resulting in a rejuvenating effect that may be achievable in a short period of time, for example 1 to 3 minutes of usage.

Due to the physical benefits experienced in a brief period of use, apparatus 100 may be particularly desirable for use by “on the go” individuals that have been stationary or on their feet for extended periods of time, e.g., travelers in an airport or shoppers in a shopping mall. For use in such environments, it may be beneficial to provide apparatus 100 with additional features, as illustrated by way of example in FIG. 6, where apparatus 100 is shown having an enclosure 170. At least one enclosure may be provided on the apparatus to shield certain components from the elements and or tampering. In this embodiment, enclosure 170 shields frame 150 (not visible, see FIG. 7), as well as transducers 112 and 122. However, it should be apparent that one or more smaller enclosures (not shown) may be utilized which, for example, shield transducers 112 and 122 separately, and may optionally shield at least a portion of frame 150. For further protection from the elements, enclosure 170 may be provided with gaskets 171, visible in FIGS. 6 and 7, which surround openings in enclosure 170 and provide a contact seal with certain components, for example the back side of plate 111 and/or backing member 124 (see FIG. 7). Enclosure 170 may be made from sheet metal, plastics, fiber reinforced plastics, or any other suitable material or combination of materials.

Optionally, as shown in FIGS. 6 and 7, a means for accepting payment 172 may be provided. The means for accepting payment may, for example, be a bill validator, a credit card processor, or a coinbox. If so provided, apparatus 100 may be used in a vending application. A timer 173 (see FIG. 7) may be used to turn on apparatus 100 for pre-selected increments of time, and/or apparatus 100 may be turned on using manual controls (not shown), or a combination of manual controls and timer. The timer 173 may be an analog or digital timer, or the timer may be integrated into a control unit such as a PLC or a microcontroller.

Armrests 130 and headrest 140 may be integral with enclosure 170 as shown in FIG. 6, or may be attached to frame 150 as shown in FIG. 1. In another example (not shown) armrests 130 and headrest 140 may be attached to enclosure 170. In any configuration, the armrests and the headrest may comprise a resilient material, or may be formed of the same material as enclosure 170. In another embodiment (not shown), vibration transducers may be provided on armrests 130.

The above-described embodiments of the massage apparatus are given only as examples. Therefore, the scope of the invention should be determined not by the illustration given, but by the appended claims and their equivalents.

What is claimed is:

1. A massage apparatus comprising: a frame; a rigid footplate; a resilient back support; a rigid backing member providing stiffness to at least a portion of the back support; a first vibration transducer providing a first vibration force to the footplate; a second vibration transducer providing a second vibration force to the back support; a first angle separating the back support and the ground in a range from about 35 degrees to about 65 degrees, a second angle separating the back support and the footplate in a range from about 75 to about 105 degrees; the footplate and the back support being isolated from the frame.

2. The massage apparatus of claim 1 further comprising first and second armrests.

3. The massage apparatus of claim 1 further comprising a headrest.

4. The massage apparatus of claim 1 wherein the first and second vibration forces are between about 50 pounds to about 150 pounds at a frequency of between about 30 Hz to about 90 Hz.

5. The massage apparatus of claim 1 wherein the first and second vibration forces are between about 85 pounds to about 115 pounds at a frequency of between about 45 Hz to about 75 Hz.

6. The massage apparatus of claim 1 wherein the first and second vibration forces are between about 95 pounds to about 105 pounds at a frequency of between about 55 Hz to about 65 Hz.

7. The massage apparatus of claim 1 wherein the first angle is in a range from about 45 degrees to about 60 degrees.

8. The massage apparatus of claim 1 wherein the second angle is in a range from about 85 degrees to about 95 degrees.

9. The massage apparatus of claim 1 further comprising means for accepting payment and a timer for controlling operation of the apparatus.

10. The massage apparatus of claim 1 further comprising at least one enclosure for shielding at least the first and second vibration transducers.

11. The massage apparatus of claim 10, further comprising a first opening in the enclosure proximate the backing member; a first gasket between the enclosure and the backing member sealing the first opening; a second opening in the enclosure proximate the footplate; a second gasket between the enclosure and the footplate sealing the second opening.

12. A massage apparatus comprising a frame, a rigid footplate, a resilient back support, a rigid backing member providing stiffness to at least a portion of the back support; a headrest; first and second armrests; a first vibration transducer attached to the footplate; a second vibration transducer attached to the backing member; a first angle separating the back support and the ground, a second angle separating the back support and the footplate; the first and second vibration transducers generating a vibration force in a range from about 85 pounds to about 115 pounds, the first angle is in a range from about 40 degrees to about 60 degrees, the second angle is in a second range from about 85 to about 95 degrees; the footplate and the back support being isolated from the frame.

13. The massage apparatus of claim 12 further comprising at least one enclosure for shielding the first and second vibration transducers.

14. The massage apparatus of claim 13 further comprising means for receiving payment and a timer for controlling operation of the apparatus.

15. The massage apparatus of claim 12 wherein the first angle is between about 45 degrees and 55 degrees.

16. The massage apparatus of claim 12 wherein the first and second vibration transducers comprise mounting surfaces and the vibration forces are applied substantially parallel to the mounting surfaces.

17. The massage apparatus of claim 12 wherein the first and second vibration transducers comprise mounting surfaces and the vibration forces are applied substantially perpendicular to the mounting surfaces.

18. A massage apparatus comprising: a frame; a rigid footplate; a resilient back support; a rigid backing member providing stiffness to at least a portion of the back support; a headrest; first and second armrests; a first vibration transducer attached to the footplate; a second vibration transducer attached to the backing member; an enclosure shielding the frame and first and second transducers, first and second openings in the enclosure generally surrounding the footplate and back support; a first gasket between the enclosure and the footplate sealing the first opening, a second gasket between the enclosure and the backing member sealing the second opening; a first angle separating the back support and the ground in a range from about 45 degrees to about 60 degrees; a second angle separating the back support and the footplate in a second range from about 85 to about 95 degrees; the first and second vibration transducers generating a vibration force between about 95 pounds to about 105 pounds; the footplate and the back support being isolated from the frame.

19. The massage apparatus of claim 18 wherein the first angle is about 52.5 degrees.

20. The massage apparatus of claim 18 wherein the second angle is about 90 degrees
